(19) United States
(12) Patent Application Publication
(10) Pub. No.: US 2005/0153779 A1
(43) Pub. Date: Jul. 14, 2005

(54) Method and system for lottery transactions over an open network

(76) Inventor: Robert Ziegler, Southlake, TX (US)

Correspondence Address: HOWISON & ARNOTT, L.L.P, P.O. BOX 741715, DALLAS, TX, 75374-1715, US

(21) Appl. No.: 11/005,499

(22) Filed: Dec. 4, 2004

Related U.S. Application Data
(60) Provisional application No. 60/526,894, filed on Dec. 4, 2003.

(51) Int. Cl. A63F 13/00

(52) U.S. Cl. 463/43

(57) ABSTRACT

A lottery management server includes a processor communicably connected to an open network. A database may be communicably connected to the processor. The processor collects lottery ticket sales information from a terminal communicably connected to the open network. The processor stores the lottery ticket sales information in the database. The processor transfers funds from a user account when a lottery ticket is purchased.

### CROSS-REFERENCE TO RELATED APPLICATIONS

This application claims priority on U.S. provisional application 60/526,894 filed Dec. 4, 2003.

### TECHNICAL FIELD OF THE INVENTION

The invention relates to the field of secured network transactions, in particular to secure lottery transaction performed over an open network.

### BACKGROUND OF THE INVENTION

The lottery has become an institution of modern life. Most lotteries are run by state organizations, so that the money collected for the lottery may be used to fund governmental operations and projects.

The Internet has become one of the most pervasive communication mediums. However, because of legal and security limitations, lottery tickets have not been available for purchase over the Internet. One of the most stringent limits is that credit cards typically may not be used for the purchase of lottery tickets, ostensibly to prevent lottery players from the financial consequences of easily borrowing money for lottery play. As well, credit laws make it easy for a credit card user to repudiate a transaction.

As such, what is needed is a lottery management system that allows the use of PIN-based debit transfers in the conduct of Internet lottery transactions.

### SUMMARY OF THE INVENTION

A lottery management server includes a processor communicably connected to an open network. A database may be communicably connected to the processor. The processor collects lottery ticket sales information from a terminal communicably connected to the open network. The processor stores the lottery ticket sales information in the database. The processor transfers funds from a user account when a lottery ticket is purchased.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a on-line lottery management system; and

FIG. 2 illustrates a process for playing the lottery over an open network.

### DETAILED DESCRIPTION OF THE INVENTION

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

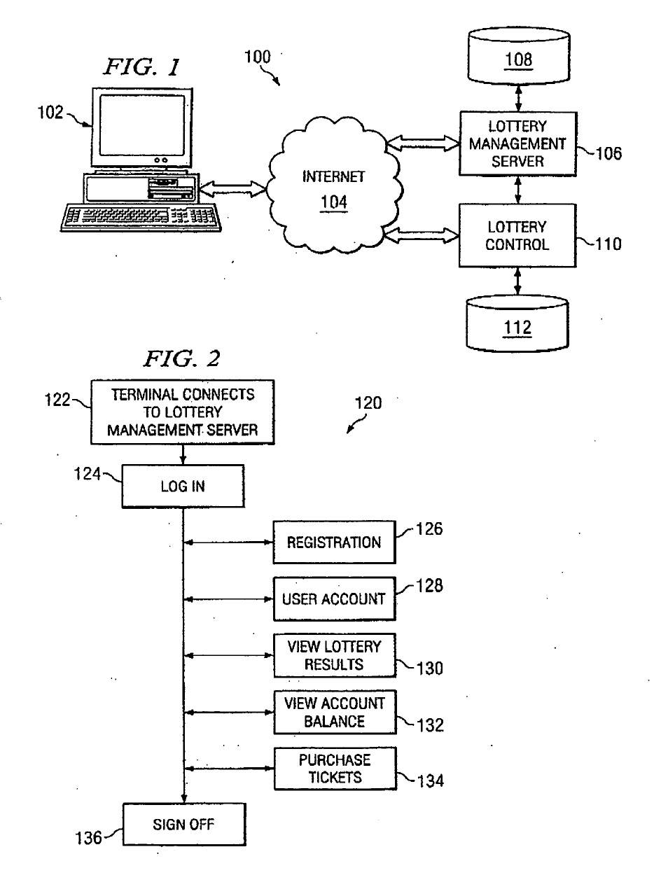

With reference to FIG. 1, a system 100 for providing lottery ticket sales over an open network is shown. A terminal 102 is connected to an open network 104. The terminal 102 may be a personal computer, an Internet appliance or any other digital processing device with an input, a display and a network connection. The open network 104 may be the Internet or any other communication network where a secured lottery transaction may be performed.

Using standard network communication protocols, the terminal 102 may communicate with lottery management server 106. The lottery management server 106 is typically implemented using a multipurpose computer executing lottery management software that manages the registration, authentication, qualification and participation in the lottery system. It will be recognized that the lottery management server 104 may be implemented using a single multipurpose computer, a dedicated lottery management appliance or a plurality of computers or devices, in communication with each other. Each participating device may be configured to execute unique components of the lottery management functions. Devices may execute some components of the lottery management in parallel with other connected devices, so that redundant functions can be implemented. The physical locations of the lottery management server components may be distributed or local.

Lottery management server 106 may be communicably connected to a database 108 or other memory storage elements. The database 108 may be used to store user identification information, associated lottery numbers and other data relevant to the lottery management functions.

Lottery management server 106 may be communicably connected to a lottery control server 110. The lottery management server 106 may be directly connected to the lottery control server by a dedicated communication line or may be connected to the lottery control server 110 through a network. Where a network connection is used between the lottery management server 106 and the lottery control server 110, the communication may be encrypted or otherwise secured.

It will be recognized that the lottery control server 110 may be implemented using a single multipurpose computer, a dedicated lottery control appliance or a plurality of computers or devices, in communication with each other. Each participating device may be configured to execute unique components of the lottery control functions. Devices may execute some components of the lottery control in parallel with other connected devices, so that redundant functions can be implemented. The physical locations of the lottery control server components may be distributed or local.

Lottery control server 110 may be communicably connected to a database 112 or other memory storage elements. The database 112 may be used to store user identification information, associated lottery numbers and other data relevant to the lottery control functions.

With reference to FIG. 2, a typical process 120 for using an on-line lottery system is shown, in accordance with one embodiment. A consumer access a lottery website using a terminal 102 communicably connected to an open network 104, such as the Internet at function block 122. A browser executed on a personal computer may be directed to establish a connection with a lottery management server 106 using an http address.

The user is prompted to enter identification information into terminal 102, performing a “log in” process to access the lottery management server 106 at function block 124. The lottery management server 104 may typically maintain a database of previously registered customers in storage 108. If the user has previously registered, the lottery management server may perform authentication processes to positively ascertain the identity of the user. The user may be prompted to enter a user ID and a password in accordance with one embodiment. Other known authentication processes including biometrics may be implemented for further security.

Where the user has not already registered, the user may be directed to a registration page on the lottery management server 106 at function block 126. The customer may be invited to register with the lottery management server 106. Registration may establish a unique user ID and a password or challenge phrase. Registration may require that the user have the ability to send or receive a confirming email. Registration may also require the placement of a digital certificate on the participant's terminal 102 to provide future verification of the user's identity.

Once registered and logged in, the user may be prompted to choose one of several options. The user may access user account information at function block 128. The user account information may include contact information for the user, financial access data and other information relevant to the user's lottery account.

The user may access a lottery result page at function block 130. The lottery result page may display the winning lottery numbers for the variety of lotteries.

The user may access an account balance page at function block 132. The account balance page may display the user's available balance as recorded by the lottery management server 106.

The user may access a lottery ticket purchase page at function block 134. The lottery ticket purchase page provides the user with the ability to choose and purchase numbers for a given lottery.

The user may sign off of the lottery management server 106 at function block 136.

As part of the registration process 126 or part of the lottery ticket purchase process 134, the lottery management server 106 may verify the physical location of the participant's terminal 102. The lottery management server 106 may request official identification information, such as a state issued driver's license. Because lotteries are often controlled by state law and state organizations, participation in lotteries is often confined to participants who reside or are presently physically present within the state. Identification of the participant and the participant's residence may be assisted using the authentication of a state-issued driver's license.

The system may require that the participant register with the provider and establish a unique name and password for their identity. The system may require that the certain eligibility areas be satisfied before the player may participate in the lottery. Eligibility may be based on the legal age of the user, the state of residency, the ticket purchase location and the availability of funds.

The system may collect registration information including a driver's license, a debit card, a mail address, an email address, a telephone number, date of birth, social security number, a username, a passcode or other identification information.

The information collected may be utilized to insure proper reporting of earnings and losses, and insure enough data is maintained for audit and traceability requirements for local, state and federal mandates.

The utilization of state issued drivers license establishes the online method of establishing The primary method for verification is based on the players state issued drivers license or ID card number. To participate in the Internet-Based lottery, players must have a valid state issued identification document and must provide the ID number from that document during registration. The number may be used to access the state license database and verify the player's age.

The system may require that the participant be a legal resident in the state operating the lottery, the system may utilize the state issued drivers license for establishment of residency, the accuracy of this data is dependant on the Department of Motor Vehicles of that state.

The online lottery system is envisioned as a closed system where non-lottery affinity is not supported. For example, merchandise sales from funds held on deposit may be prohibited to eliminate money laundering risks and reduce the risk management and reporting requirements during operation.

The funds on deposit or proceeds from collections may be used for further participation in the lottery or may be transferred back to the primary account of record as linked to the Debit/ATM card during registration.

The “Funds on Deposit” may be regulated by the state or other regulatory bodies. The lottery management server 106 allows for maximum and minimum amounts to be maintained across the lottery or by individual participant.

The lottery management server 106 may automatically settle funds due participant for sums less than the “Collection Limit, the proceeds that exceed the “Collection Limit” must be collected at the collection facility as operated by the state. The participant may be required to bring “Proof of Identity” to the collection office for presentment and to authorize release of funds. A collection limit may be set by the lottery commission and enforced by the lottery management server 106.

The participant's identity may subsequently be established by the UserId and Passcode, as established during the “Registration” process.

The identity of the participant may be challenged if fraudulent activity is identified during the operations of the system, or at the request of the state, or at the request of the participants financial institution. The credentials used for registration may be periodically validated to insure they are still valid instruments, the frequency shall be determined on a state by state basis.

The lottery management server 106 may determine if the participant is eligible to participate. The geographic location and boundary conditions of a lottery may be used to include or exclude participation depending on factors established by the lottery management server 106, lottery control server 110 or in conjunction with a state lottery organization. Participation may be extended to additional states for multi-state lotteries. Various restrictions are common to lottery regulations and may be enforced by the lottery management server 106.

The lottery management server 106 may collect, hold and dispense money on behalf of the participant for use in the lottery system. The lottery management server 104 may prompt the participant to use a PIN-based on-line debit system to transfer money from a bank account to a virtual wallet maintained at the lottery management server 106. The money in the virtual wallet may be used to purchase lottery tickets from the lottery management server. A virtual wallet may also be called a virtual account or an on-line account.

The presentation of the lottery ticket options will depend on the specifics of the lottery game. Typically a sequence of numbers is chosen by the participant. A random number may be generated. Other types of choices may be presented to the participant. When the final selection is made and confirmed, the cost of the lottery ticket is deducted from the participant's virtual wallet. A transaction summary may be displayed to the participant, for viewing, saving or printing. The process is repeated as often as the participant chooses to play the online lottery.

The lottery management server 106 may generate a unique ID number for each set of lottery numbers. The unique ID may be stored in a secure database 108. The unique ID number associated with the lottery numbers may be submitted to the lottery control server. The lottery numbers may processed by the lottery control server 110 in the same manner as any retail lottery ticket purchase. Typically, the lottery control server 110 issues a serial number and confirmation code. Alternatively, the serial number and confirmation code may be issued by the lottery management server, acting as a provider and authority for internet lottery. The serial number and confirmation number may be stored with the participant's ticket information in secure database 108.

The lottery numbers are processed in the same manner as any retail lottery ticket purchase. The lottery numbers are issued a serial number and confirmation code by the lottery management server 106 or the lottery control server 110. The numbers may be stored with the original ticket information in the secure database 108 or 112.

After all number sets are processed and the confirmations stored in the database 108, a listing of the number sets and their corresponding authentication data is displayed for the player. This list is not a bearer document (as with a retail lottery slip) but simply a method for the player to print a history of his/her transaction.

The lottery management server 106 tracks the purchased numbers, storing them in association with the participant identification information along with confirmation data or other data necessary to the lottery game. The data, summaries of the data or analysis of the data, may be delivered or available to a state lottery organization.

When the lottery ends and winning numbers are issued by the lottery authority, the winning lottery numbers are provided by the lottery control server 110 to the lottery management server 106. Winning numbers are matched against the purchased ticket numbers by the lottery management server 106 and winning participants are identified. The lottery management server 106 may transfer the winnings from a lottery bank account to the winning participant's virtual wallet. The money in the virtual wallet may be transferred to the participant's bank account or used to purchased further lottery tickets.

Limits with regard to losses, velocity or other restrictions may be enforced by the lottery management server. As is standard in lottery management, winnings in excess of a defined amount may require the participant to visit a lottery office to collect the winnings.

This hosted solution enables all facets of lottery management for the Internet, including payment, collections, analysis, reporting and a configurable back-office for integration to other lottery providers for consolidated reporting and game management.

By using a Debit/ATM card with a PIN to conduct the financial transactions, the financial transactions are non-reputable by the participant. The process may provide real-time authorizations for the users.

The lottery management server 106 may track the velocity and frequency of use. Velocity and frequency may be measured for ticket selection, wins and losses, payment including funding and withdrawls, userID and terminal 102.

The lottery management server 106 may track participant utilization, enabling the system to determine who is purchasing tickets, how much is being purchased and even how much is being purchased from each personal computer. The lottery management server 106 can be configured to loosen or tighten controls in order to prevent abusive including compulsive or addictive behavior in regards to lotteries. Spending tracking controls may be implemented and may enforce limits where required.

The location of the participant's terminal 102 when a purchasing an online lottery ticket may be determined by evaluating the geo-location of the participant's terminal 102. The lottery management server may incorporate client-side technology to evaluate and determine the location of the terminal 102. The client-side software may deny access to the online lottery if no clear boundary is discernable, and if the location is deemed to be in a non-authorized, non-lottery jurisdiction.

The participants accounts may be funded exclusively through the use of a PIN-Debit payment service. The funds residing in the participants account can be withdrawn at any time, and may be returned to the participants account exclusively through the use of the ATM Direct PIN-Debit payment service. The funds must be returned to the account used to make the initial deposit into the player's account.

The participant after successfully logging into the online lottery can check their virtual tickets for winnings, and are automatically credited to the participants virtual account. The system typically will not provide pro-active notification to winners to protect the privacy of the participants, although such pro-active notification could be implemented where appropriate.

The system may generate virtual tickets that may be displayed and printed for the physical records of the participant. The terminal 102 may print a replication of the “Virtual Ticket’ generated by the system. There may be no common ticket stock utilized by the lottery service for the printing of virtual tickets.

The lottery management server may provide information to lottery commissions and other game providers, as needed, to insure that lottery sales totals are accurate and timely. All personal information collected may protected with data encryption technology during collection and transmittal.

The participant may be provided a telephone number to assist with usage of the lottery management system 100 to maximize participation and security for all parties.

It will be appreciated by those skilled in the art having the benefit of this disclosure that this invention provides a secure Internet lottery system and method. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. A lottery management server comprising:
a processor communicably connected to an open network;
a database communicably connected to the processor;
wherein said processor collects lottery ticket sales information from a terminal communicably connected to the open network and stores said lottery ticket sales information in said database and wherein said processor transfers funds from a user account when a lottery ticket is purchased.

2. The lottery management server of claim 1, wherein said processor is connected to a lottery control server.

3. The lottery management server of claim 2, wherein said processor receives lottery result information from said lottery control server.

4. The lottery management server of claim 2, wherein said processor transfers funds to a user account when the lottery result information indicates a win.

5. The lottery management server of claim 1, wherein said processor receives user identification information from said terminal.

6. The lottery management server of claim 2, wherein said user identification information includes information identifying a PIN-based debit card.

7. The lottery management server of claim 1, wherein said processor uses a PIN-based debit transaction to transfer funds.

8. The lottery management server of claim 1, wherein said processor uses a PIN-based debit transaction to authenticate a user.

9. The lottery management server of claim 1, wherein said processor uses a PIN-based debit transaction to identify the location of the terminal.

10. The lottery management server of claim 1, wherein said processor provides a web page interface to the terminal.

11. A method of providing a lottery over an open network comprising the steps of:
providing a user interface over an open network;
receiving user identification information over said open network;
associating lottery numbers with said user identification information; and
withdrawing user funds to pay for the purchase of lottery numbers.

12. The method of claim 11, further comprising the step of communicating lottery number purchase information to a lottery control server.

13. The method of claim 12, further comprising the step of receiving lottery result information from said lottery control server.

14. The method of claim 13, further comprising the step of transferring funds to a user account when the lottery result information indicates a win.

15. The method of claim 11, wherein said processor authenticates the user identification information.

16. The method of claim 11, wherein said user identification information includes information identifying a PIN-based debit card.

17. The method of claim 11, further comprising the step of using a PIN-based debit transaction to transfer funds.

18. The method of claim 1, further comprising the step of using a PIN-based debit transaction to authenticate a user.

19. The method of claim 11, further comprising the step of using a PIN-based debit transaction to identify the location of the terminal.

20. The method of claim 11, wherein said user interface is a web page interface.
